(19) United States
(12) Patent Application Publication
(10) Pub. No.: US 2015/0119215 A1
(43) Pub. Date: Apr. 30, 2015

(54) SINGLE POWER TOOL CHANGING DEVICE OF CNC MACHINING CENTER

(71) Applicant: FENG-TIEN CHEN, Taichung City (TW)

(72) Inventor: FENG-TIEN CHEN, Taichung City (TW)

(21) Appl. No.: 14/064,193

(22) Filed: Oct. 28, 2013

(51) Int. Cl. B23Q 3/155

(52) U.S. Cl. CPC B23Q 3/15513; B23Q 3/15526; B23Q 3/1554
USPC 483/67

(57) ABSTRACT

A single power tool changing device of a CNC machining center includes a tool magazine unit, a cam-based tool changing unit, and a power clutch unit. The tool magazine unit includes a tool magazine body, a rotatable disk, and a plurality of tool sets. The cam-based tool changing unit includes a tool change base, a cam mechanism, and a tool changing mechanism. The power clutch unit includes a first force output axle that drives the tool magazine unit to operate, a second force output axle that drives the cam-based tool changing unit to operate, and a power mechanism, which selectively transmits power to the first or second force output axle. As such, the present invention allows for performance of both operations of tool selection and tool change with a single driving power source so as to achieve an advantage of reducing installation cost.

### (a) TECHNICAL FIELD OF THE INVENTION

The present invention generally relates to a CNC (Computer Numeric Control) machining center, and more particularly to a single power tool changing device of a CNC machining center that uses a single driving power source to carry out two different operations of tool selection and tool change.

### (b) DESCRIPTION OF THE PRIOR ART

Referring to FIG. 1, a conventional CNC machining center 10 generally comprises a machining spindle head 11, a tool magazine unit 12, and a tool change unit 13. The machining spindle head 11 has a lower end to which a tool 100 is mounted and fixed. The tool magazine unit 12 comprises a tool magazine body 121, a rotatable disk 122 mounted to the tool magazine body 121 for rotation movement, a plurality of tool receptacles 123 mounted to the rotatable disk 122 and respectively receiving various tools 100 therein, and a first motor 124 mounted to the tool magazine body 121 to drive the rotatable disk 122 to rotate. The tool change unit 13 comprises a tool change base 131, a cam mechanism (not shown) mounted inside the tool change base 131, a tool changing arm 132 rotatably mounted to the tool change base 131 and driven by the cam mechanism, and a second motor 133 mounted to the tool change base 131 to drive the cam mechanism to operate. When a user attempts to carry out a tool selection operation, the first motor 124 is first actuated to drive the rotatable disk 122 of the tool magazine unit 12 to rotate so that the rotatable disk 122 moves the tool 100 that is desired by the user to a tool change position at a lower side thereof for being standby. When the user attempts to carry out a tool change operation, the second motor 133 is actuated to drive the cam mechanism of the tool changer unit 13 to operate. Based on a predetermined cam route in combination with the operation of a tool change program, the cam mechanism causes the tool changing arm 132 to rotate in such a way that the two ends thereof are moved to reach the tool change positions of the tool magazine unit 12 and the machining spindle head 11 to then simultaneously grip the tools 100 at both sides and simultaneously remove the tools 100 of both sides. Afterwards, the tool changing arm 132 is caused to rotate 180 degrees to switch the positions of the tools 100 of both sides. Finally, the tool changing arm 132 simultaneously put the tools 100 into the tool receptacle 123 and the machining spindle head 11 to complete the entire process of the tool change operation.

The tool magazine unit 12 and the tool changer unit 13 described above are effective in realizing operations of tool selection and tool change. However, there is a drawback existing in such an arrangement. The conventional CNC machining center 10 is provided with a first motor 124 that is provided in the tool magazine unit 12 to be dedicated for driving the rotatable disk 122 and a second motor 133 that is provided in the tool changer unit 13 to be dedicated for driving the cam mechanism. The first motor 124 and the second motor 133 are respectively mounted to the tool magazine unit 12 and the tool changer unit 13 in such a way that they are independent of each other. Thus, the entire tool change system requires two motors 124, 133 and the two motors 124, 133 individually need their won servo control circuit and the likes. The more the number of the motors is, the higher the installation cost will be.

### SUMMARY OF THE INVENTION

Thus, an object of the present invention is to provide a single power tool changing device of a CNC machining center that allows operations of tool selection and tool change to be carried out with a single power source.

The present invention provides a single power tool changing device of a CNC machining center, which comprises a tool magazine unit, a cam-based tool changing unit, and a power clutch unit, wherein the tool magazine unit comprises a tool magazine body, a rotatable disk that is rotatably mounted to the tool magazine body, a plurality of tool sets mounted on the rotatable disk, and a first rotation member operatively coupled to the rotatable disk, whereby rotation of the first rotation member causes the rotatable disk to rotate to carry out a tool section operation; the cam-based tool changing unit comprises a tool change base disposed at one side of the tool magazine body, a cam mechanism arranged in the tool change base, a tool changing mechanism mounted on the tool change base and driven by the cam mechanism, and a second rotation member operatively coupled to the cam mechanism, the tool changing mechanism comprising a tool changing arm that is rotatably movable, whereby rotation of the second rotation member causes the cam mechanism to operate to have the tool changing arm carry out a tool change operation; and the power clutch unit comprises a fixed seat, a movable seat slidably mounted on the fixed seat, a pusher assembly operable to selectively move the movable seat, a first force output axle mounted on the fixed seat to selectively drive the first rotation member to rotate, a second force output axle mounted on the fixed seat to selectively drive the second rotation member to rotate, and a power mechanism, the power mechanism comprising a motor and a power output spindle that is mounted on the movable seat and is operatively coupled to the motor, whereby the movement of the movable seat caused by the pusher assembly allows the power output spindle to selectively engage with the first or second force output axle for transmission of power.

The efficacy of the present invention is that the power clutch unit is provided with a power mechanism and the power mechanism is capable of selectively driving the tool magazine unit or the cam-based tool changing unit to operate so that the present invention allows operations of tool selection and tool change to be carried out with a single driving power source thereby achieving an advantage of reducing installation cost.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an assembled of a conventional tool change device of a machine tool.

FIG. 2 is a perspective view showing a single power tool changing device of a CNC machining center according to a first preferred embodiment of the present invention, illustrating that the present invention comprises a tool magazine unit, a cam-based tool changing unit, and a power clutch unit, wherein the power clutch unit is mounted at a location corresponding to an external circumference of the tool magazine unit.

FIG. 3 is an exploded view of the preferred embodiment.

FIG. 4 is also an exploded view of the preferred embodiment taken at a different perspective.

FIG. 5 is an assembled view of the preferred embodiment.

FIG. 6 is a cross-sectional view taken along line VI-VI of FIG. 5, illustrating that the power clutch unit uses a first rotation member to drive the tool magazine unit.

FIG. 7 is a cross-sectional view taken along line VII-VII of FIG. 5, illustrating that the power clutch unit uses a second rotation member to drive the cam-based tool changing unit.

FIG. 8 is a cross-sectional view taken along line VIII-VIII of FIG. 7, illustrating engagement between the power clutch unit and the first rotation member and the second rotation member.

FIG. 9 is an exploded view of the preferred embodiment, illustrating that the power clutch unit comprises a first force output axle, a second force output axle, a first brake member, a second brake member, and a power mechanism.

FIG. 10 is a schematic view illustrating an operation of the preferred embodiment, illustrating the power mechanism drives the first force output axle to rotate.

FIG. 11 is a cross-sectional taken along line XI-XI of FIG. 10.

FIG. 12 is a schematic view illustrating an operation of the preferred embodiment, illustrating the power mechanism drives the second force output axle to rotate.

FIG. 13 is a cross-sectional view taken along line XIII-XIII of FIG. 12.

FIG. 14 is an exploded view of a second preferred embodiment of the present invention, illustrating that the present invention comprises a tool magazine unit, a cam-based tool changing unit, and a different power clutch unit.

FIG. 15 is a cross-sectional view of the preferred embodiment, in an assembled form, illustrating the power clutch unit is mounted at a position corresponding to a central portion of the tool magazine unit.

FIG. 16 is a cross-sectional view taken along line XVI-XVI of FIG. 15.

FIG. 17 is a cross-sectional view taken along line XVII-XVII of FIG. 15.

FIG. 18 is a schematic view illustrating an operation of the preferred embodiment, illustrating that the power clutch unit comprises a power mechanism that is movable up and down and comprises a motor, a power output spindle, and a universal joint.

FIG. 19 is a cross-sectional view of a third preferred embodiment of the present invention, illustrating that the power clutch unit of the present invention comprises a brake member, which selectively locks first and second force output axles through engagement with a spur gear.

FIG. 20 is a cross-sectional view of a fourth preferred embodiment of the present invention, illustrating that the power clutch unit of the present invention comprises a brake member, which selectively locks first and second force output axles through engagement with friction surfaces.

FIG. 21 is a cross-sectional view of a fifth preferred embodiment of the present invention, illustrating that the power clutch unit of the present invention comprises a brake member, which selectively locks first and second force output axles through engagement with bevel gears.

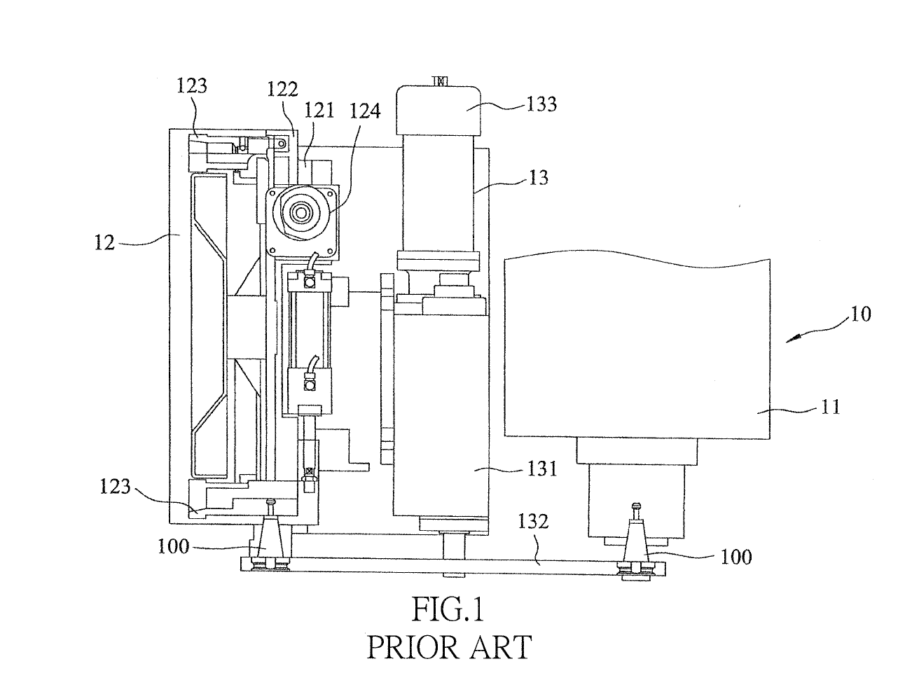

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

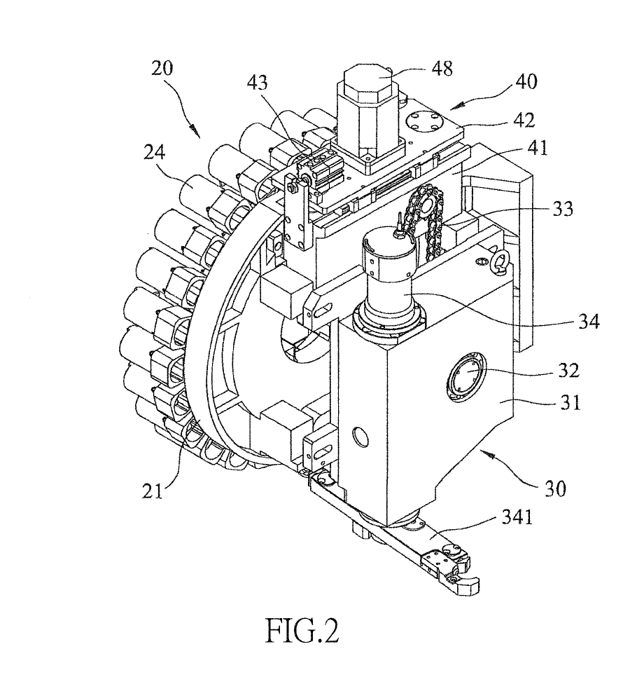

Referring to FIG. 2, a single power tool changing device of a CNC machining center according to a first embodiment of the present invention generally comprises a tool magazine unit 20, a cam-based tool changing unit, 30 and a power clutch unit 40. Next, in the following, the constituent components of each of the above-described units of the present invention, as well as the spatial arrangements thereof, will be described.

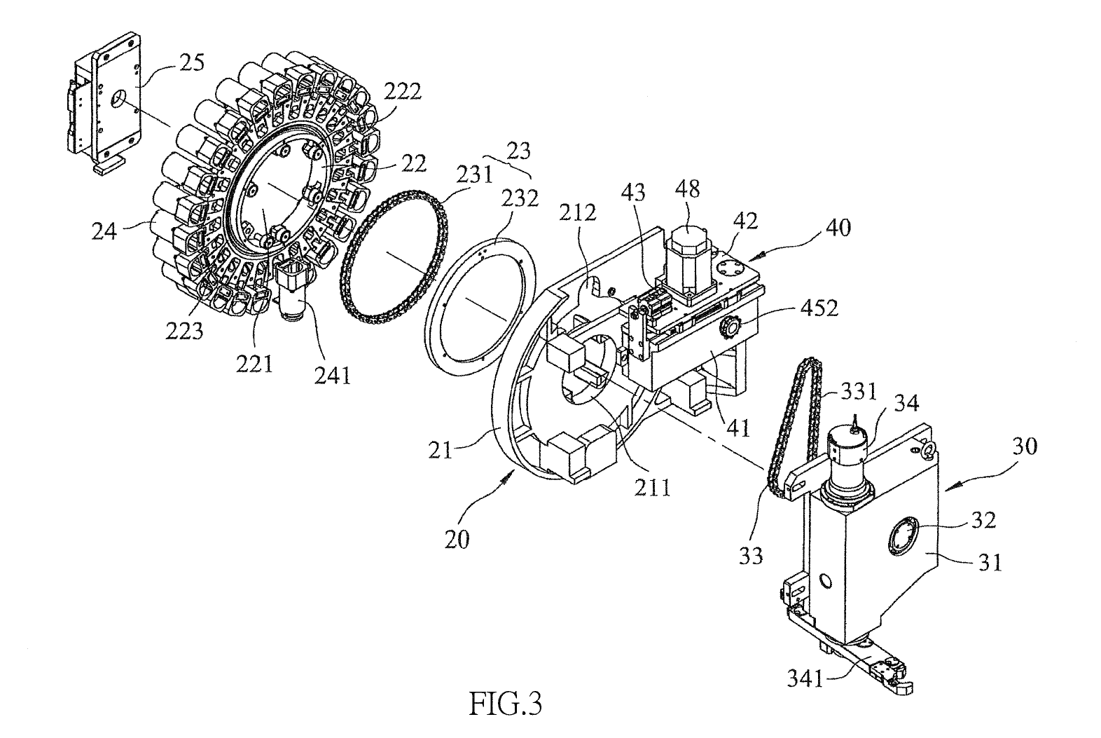

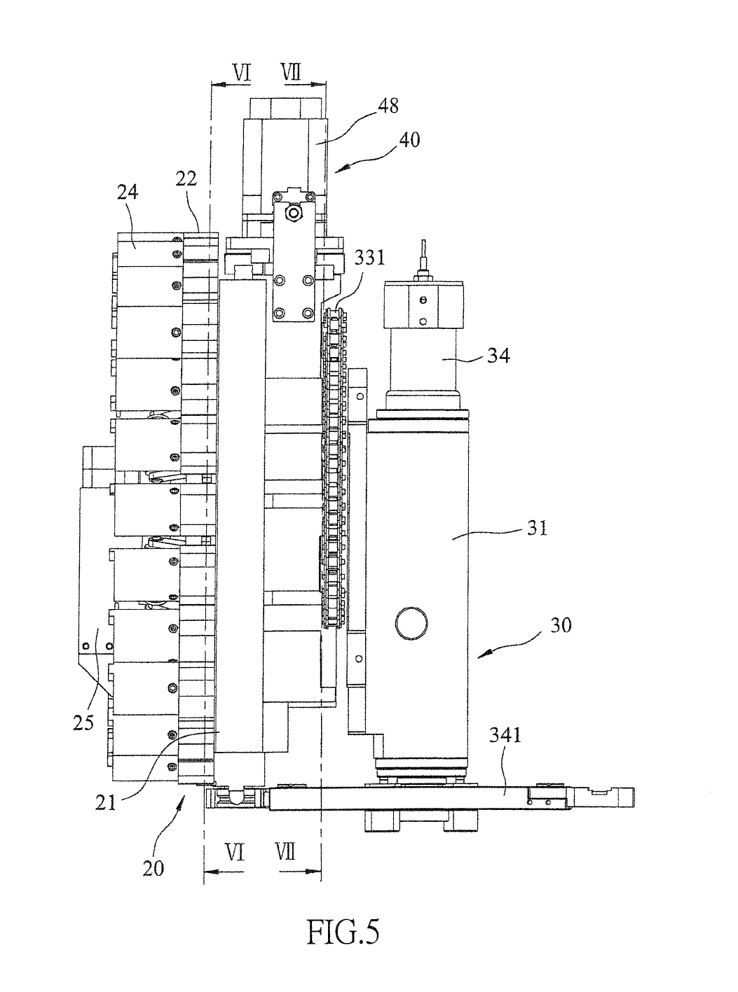

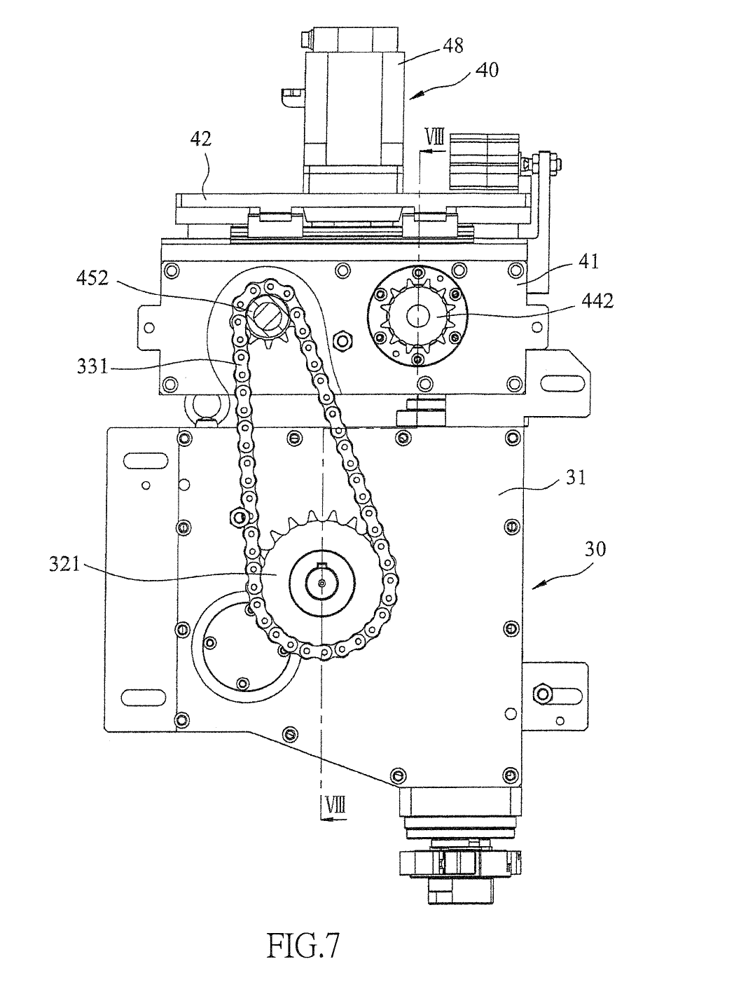

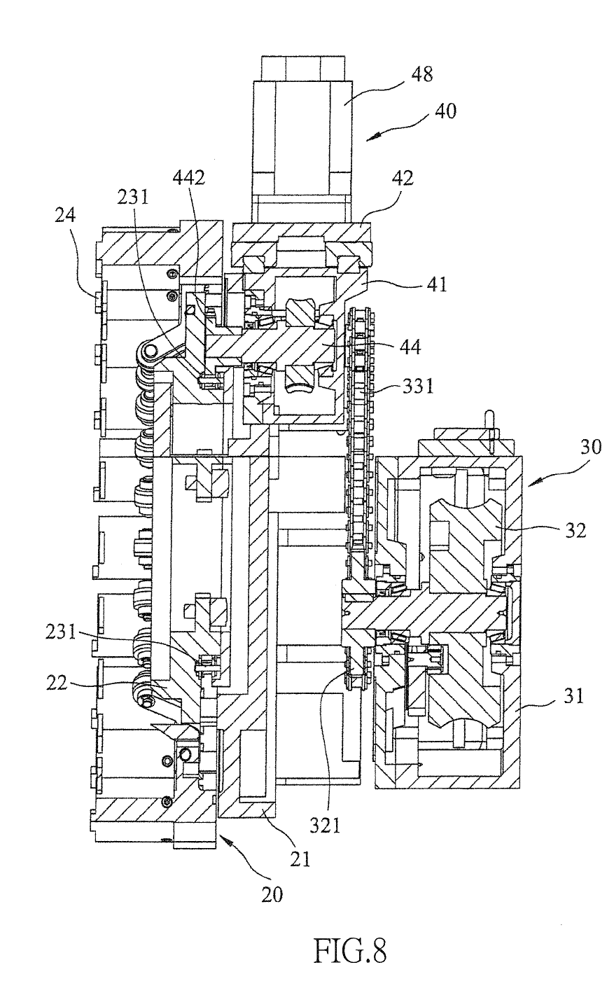

Referring to FIGS. 3-8, the tool magazine unit 20 comprises a tool magazine body 21, a rotatable disk 22 rotatably mounted to the tool magazine body 21, a first rotation member 23 operatively coupled to the rotatable disk 22, a plurality of tool sets 24 mounted and lined up on the rotatable disk 22, and a tool guiding mechanism 25 disposed alt a lower portion of the tool magazine body 21 to push and drive the tool sets 24 down to a tool change position. In the instant embodiment, the tool magazine body 21 comprises a circular mounting 211 raised from a central portion thereof. The tool magazine body 21 comprises an open recess formed in an upper portion thereof to define a notch 212. The rotatable disk 22 comprises a circular mounting hole 221 formed in a center thereof. Arranged in the form of a circumferential array on an inner circumferential surface of the circular mounting hole 221 is a plurality of cylindrical bearings 222, whereby the bearings 222 are in rolling engagement with the circular mounting 211 of the tool magazine body 21. Although the rotatable disk 22 carries a large load of gravity of the plurality of tool sets 24, the combination described above in respect of the bearings 222 allows for stable and smooth rotation of the rotatable disk 22 with respect to the tool magazine body 21. The rotatable disk 22 comprises, in a recessed form, an annual groove 223. In the instant embodiment, the first rotation member 23 generally comprises a first chain 231 received in the annual groove 223 and a ring lid 232 set on the annular seat 223 to confine the first chain 231. The first chain 231 is a circular chain with flexibility and opposite sides of a pivot joint of each link of the chain is coupled to the rotatable disk 22 in a pin-and-hole fashion so that the first chain 231 is fixed to and movable in unison with the rotatable disk 22. The manufacture of the chain is simple and the cost is low and requires no high precision of dimensions so that assembling and replacement for maintenance are easy. Compared to the conventional transmission structure where engagement is made between rigid toothed wheels, the chain-based transmission according to the present invention has an effect of lowering down the cost. Each of the tool sets 24 comprises a tool receptacle 241 and a tool (not shown) received and retained in the tool receptacle 241. The plurality of tool set 24 is mounted on the rotatable disk 22, whereby when a user has made a selection of a desired one of the tools, the rotatable disk 22 moves desired tool set 24 to a lower position, where the tool guiding mechanism 25 is then operated to push and move the tool set 24 to a tool change position at a lower side to get standby.

The cam-based tool changing unit 30 comprises a tool change base 31 set at one side of the tool magazine body 21, a cam mechanism 32 arranged in the tool change base 31, a second rotation member 33 disposed outside the tool change base 31 and operatively coupled to the cam mechanism 32, and a tool changing mechanism 34 mounted to the tool change base 31 and driven by the cam mechanism 32. The tool change base 31 has a hollow interior space in which the cam mechanism 32 and the tool changing mechanism 34 are mounted. The cam mechanism 32 and the tool changing mechanism 34 are of known structures of which the arrangement and operation will not be described. The tool changing mechanism 34 comprises a rotatable tool changing arm 341. The tool changing arm 341, under being driven by the cam mechanism 32, has two opposite ends that grip tools for tool changing. In the instant embodiment, the cam mechanism 32 comprises a drive sprocket 321 arranged externally of the tool change base 31. The second rotation member 33 comprises a second chain 331 set around the drive sprocket 321, whereby with the second chain 331 driving the drive sprocket 321, the cam mechanism 32 is set in operation and drives the tool changing mechanism 34 to carry out a tool change operation.

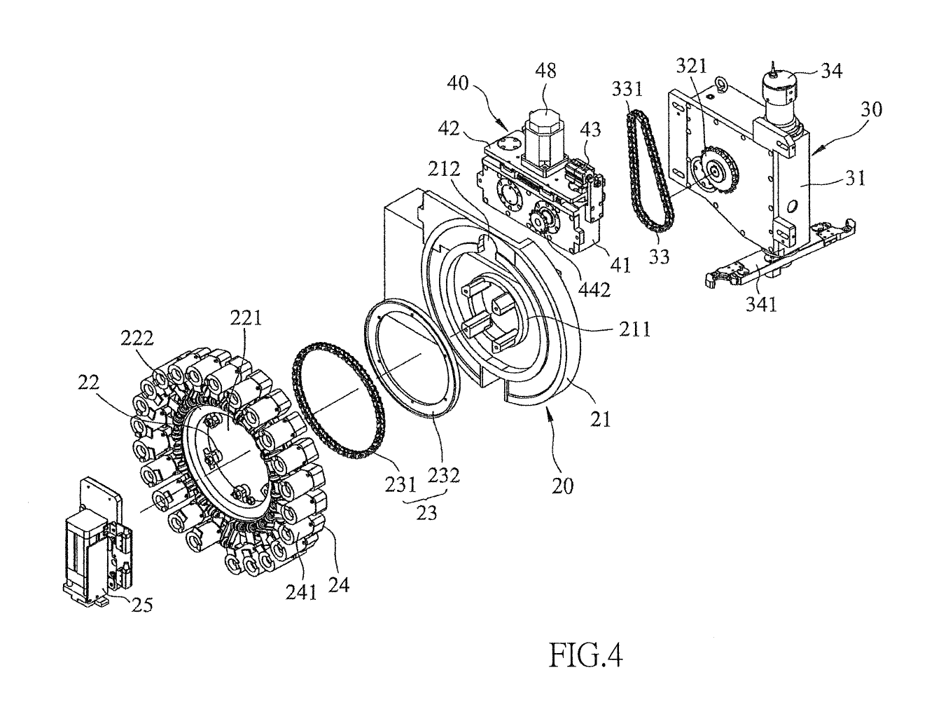

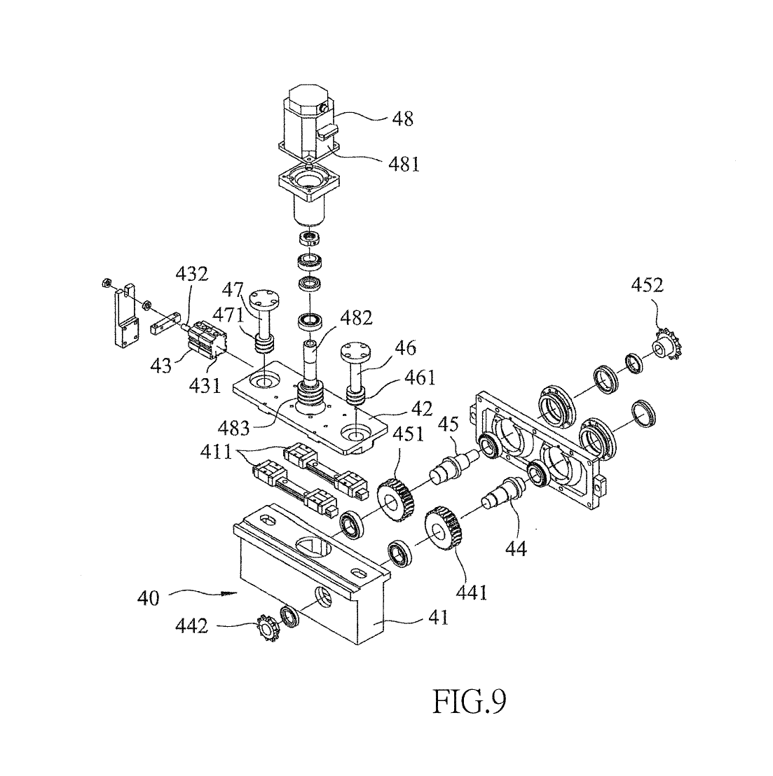

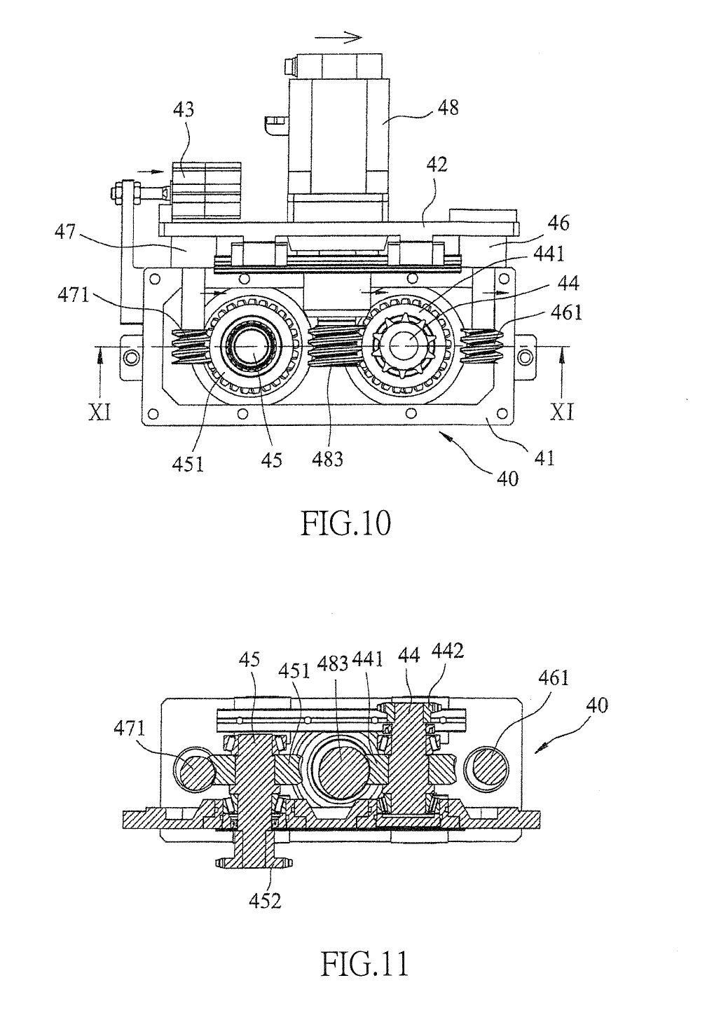

Referring to FIGS. 9-11, the power clutch unit 40 is mounted outside the tool magazine body 21 and comprises a fixed seat 41, a movable seat 42 slidably mounted on the fixed seat 41, a pusher assembly 43 for pushing and driving the movable seat 42, a first force output axle 44 rotatably mounted to the fixed seat 41, a second force output axle 45 rotatably mounted to the fixed seat 41, a first brake member 46 mounted to an end of the movable seat 42 and extending into an interior of the fixed seat 41, a second brake member 47 mounted to an opposite end of the movable seat 42 and extending into the fixed seat 41, and a power mechanism 48 mounted on the movable seat 42. The fixed seat 41 is arranged at an upper portion of the tool magazine body 21 and the fixed seat 41 comprises two slide rails 411 arranged thereon. The movable seat 42 is mounted, in a slidable manner, on the two slide rails 411. The pusher assembly 43 may comprise a pneumatic or hydraulic power device or an electromagnetic valve assembly. In the instant embodiment, the pusher assembly 43 comprises a cylinder 431 fixed to the movable seat 42 and an extendible central rod 432 received in the cylinder 431. An end of the central rod 432 is coupled to the fixed seat 41, whereby when the central rod 432 extends/retracts, the movable seat 42 is caused, in entirety, to do linear movement along the slide rails 411. Also referring to FIGS. 4, 6, and 7, the first force output axle 44 comprises a first transmission gear 441 arranged in the interior of the fixed seat 41 and a first chain wheel 442 arranged outside the fixed seat 41. The first chain wheel 442 is forward extended to penetrate through the notch 212 of the tool magazine body 21 to engage an external perimeter of the first chain 231, so that the first force output axle 44 may drive the tool magazine unit 20 to rotate. The second force output axle 45 comprises a second transmission gear 451 arranged in the interior of the fixed seat 41 and a second chain wheel 452 arranged outside the fixed seat 41. The second chain wheel 452 is set to couple with the second chain 331 and the drive sprocket 321 to achieve transmission, whereby the second force output axle 45 may drive the cam-based tool changing unit 30 to rotate. The first brake member 46 and the second brake member 47 are coupled to the movable seat 42 and are movable in unison with the movable seat 42 and the power mechanism 48. The first brake member 46 comprises a first locking toothed wheel 461 that is engageable, in a separable manner, with the first transmission gear 441. The second brake member 47 comprises a second locking toothed wheel 471 that is engageable, in a separable manner, with the second transmission gear 45I. In the instant embodiment, the transmission gears 441 (451) and the locking toothed wheels 461 (471) are combinations of worm and worm gears. It is also possible to use other type of combinations for mating engagement, of which further details will be given hereafter. The power mechanism 48 comprises a motor 481 fixed to the movable seat 42, a power output spindle 482 rotatably mounted to the movable seat 42 and operatively coupled to the motor 481, and a drive gear 483 mounted to an end of the power output spindle 482. In the instant embodiment, the motor 481 comprises a servo motor and the power output spindle 482 is located between the first force output axle 44 and the second force output axle 45, whereby movement of the movable seat 42 allows the drive gear 483 to selectively mate the first transmission gear 441 or the second transmission gear 451 for transmission.

The forgoing provides a description of the structure and shape of the single power tool changing device of the CNC machining center according to the present invention. Next, the use and operation of the present invention and performance achieved thereby will be described.

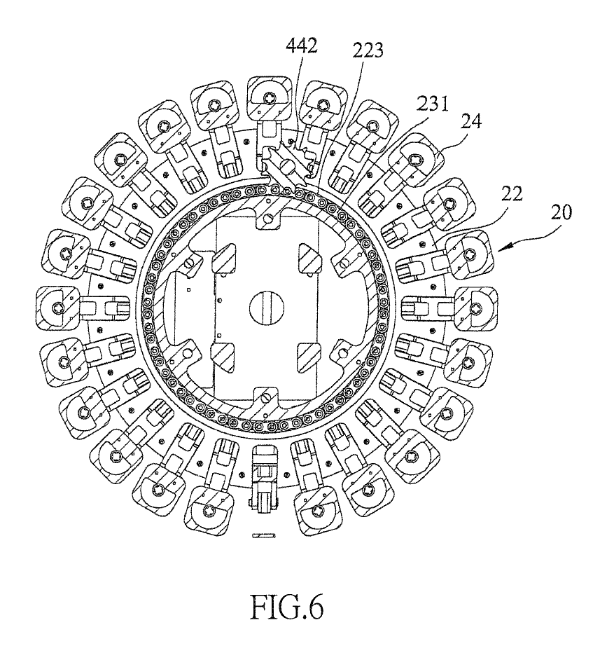

Referring to FIGS. 6, 10, and 11, when a user wishes to put the tool magazine unit 20 into operation, the pusher assembly 43 of the power clutch unit 40 is caused to move the movable seat 42 to a first position, where the drive gear 483 of the power mechanism 48 and the first transmission gear 441 of the first force output axle 44 engage each other for power transmission. The first force output axle 44 then uses the first chain wheel 442 to drive the first rotation member 23, and the first rotation member 23 in turn drives the rotatable disk 22 of the tool magazine unit 20 to rotate, whereby the tool set 24 that the user wishes to select is moved to the tool change position at the lower end of the rotatable disk 22 to complete the tool selection operation. Under this condition, the first locking toothed wheel 461 and the first transmission gear 441 that are arranged in the interior of the power clutch unit 40 are set in a separate condition, while the second locking toothed wheel 471 is in engagement with the second transmission gear 451 so that the second force output axle 45 is set in a locked condition.

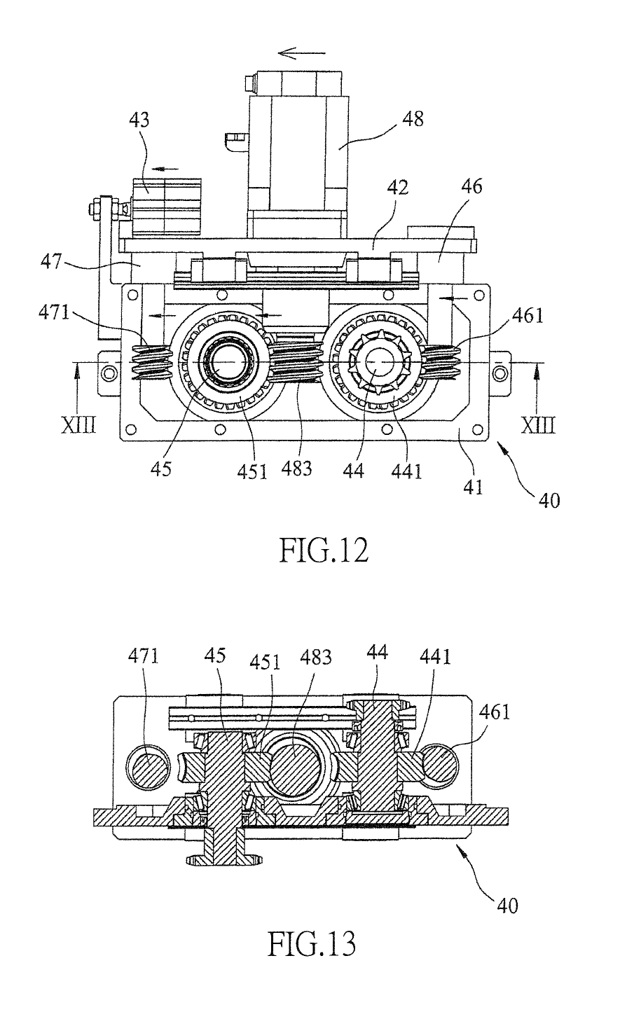

Referring to FIGS. 3, 7, 12, and 13, when the uses attempts to put the cam-based tool changing unit 30 into operation, the pusher assembly 43 of the power clutch unit 40 is caused to move the movable seat 42 to a second position, where the drive gear 483 of the power mechanism 48 and the second transmission gear 451 of the second force output axle 45 are in engagement with each other. The second force output axle 45 then uses the second chain wheel 452 to drive the second rotation member 33, and the second rotation member 33 drives the drive sprocket 321 of the cam-based tool changing unit 30 so as to set the cam mechanism 32 and the tool changing mechanism 34 in operation, whereby the tool changing arm 341 is caused to grip the tool set 24 set at the tool change position and to have the tools that are located on the machining spindle head (not shown) and the tool magazine unit 20 exchange with each other to thereby complete the tool change operation. Under this condition, the second locking toothed wheel 471 and the second transmission gear 451 that are arranged in the interior of the power clutch unit 40 are set in a separate condition, while the first locking toothed wheel 461 is in engagement with the first transmission gear 441 so that the first force output axle 44 is set in a locked condition. The purposes of setting the first force output axle 44 under a locked condition is that when the rotatable disk 22 carries a tool set 24, once losing driving power, the rotatable disk 22 may instantaneously drops due to the weight of the tool set 24. For such a reason, the present invention is designed to have the first force output axle 44 locked in order to avoid the potential risk of sudden drop of the rotatable disk 22.

In summary, the present invention provides the single power tool changing device of the CNC machining center generally for overcoming the drawbacks of the conventional tool changing devices. The technical solution of the present invention includes a first rotation member 23 is provided on the tool magazine unit 20 for driving the rotatable disk 22 to carry out a tool selection operation and a second rotation member 33 is provided on the cam-based tool changing unit 30 for driving the tool changing mechanism 34 to carry out a tool change operation and to provide a fixed seat 41, a movable seat 42, a first force output axle 44, a second force output axle 45, and a power mechanism 48 on the power clutch unit 40 in such a way that the first force output axle 44 is operable to drive the first rotation member 23 and the second force output axle 45 is operable to drive the second rotation member 33, so that through controlling a movement of the movable seat 42, the power mechanism 48 is allowed to selectively engage the first force output axle 44 or the second force output axle 45 for power transmission. The present invention uses a single set of power mechanism 48 to serve as power source for the operations of both the tool magazine unit 20 and the cam-based tool changing unit 30. In this way, installation of additional motor 481 can be avoided so as to greatly reduce the installation cost of the tool change system.

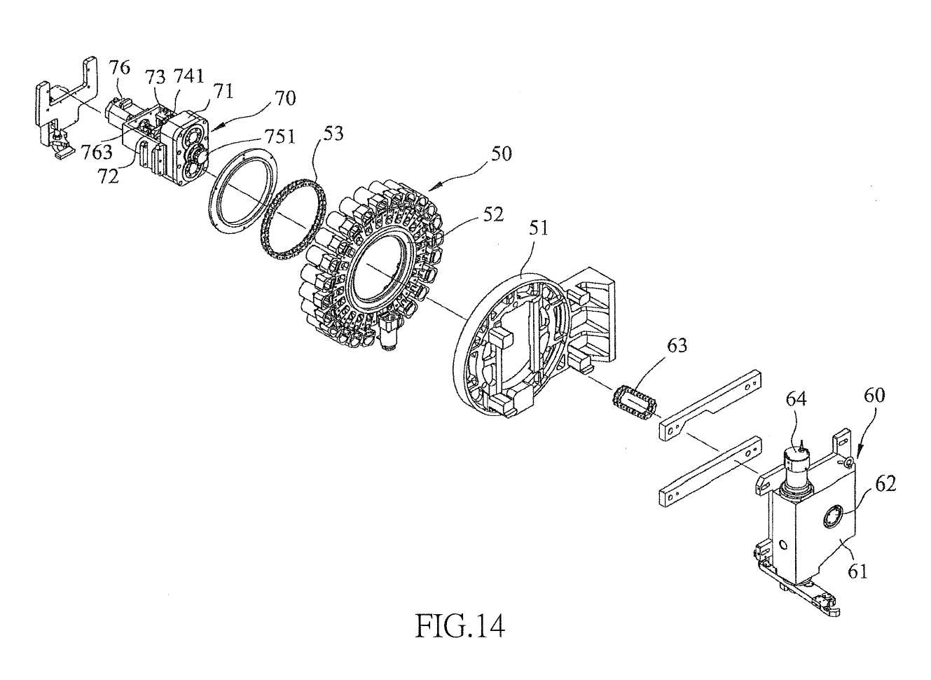

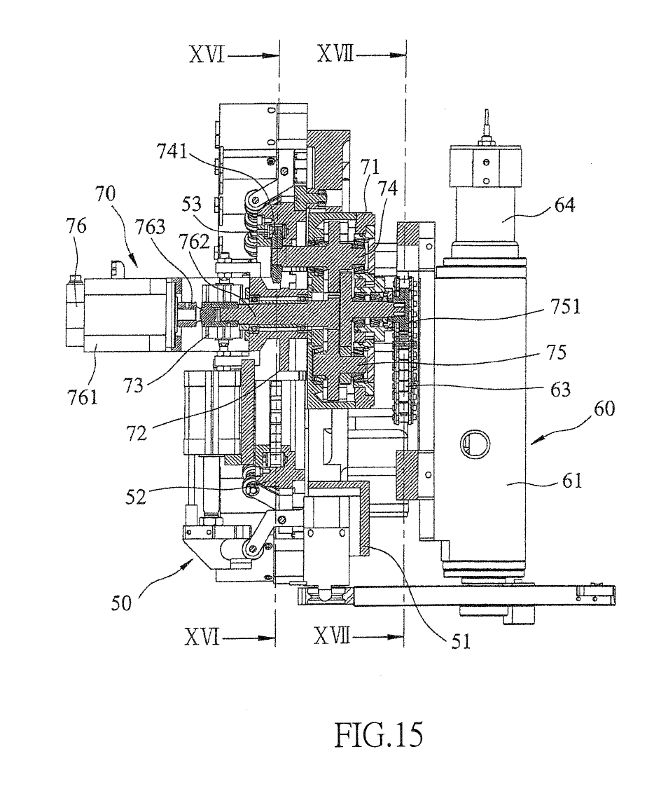

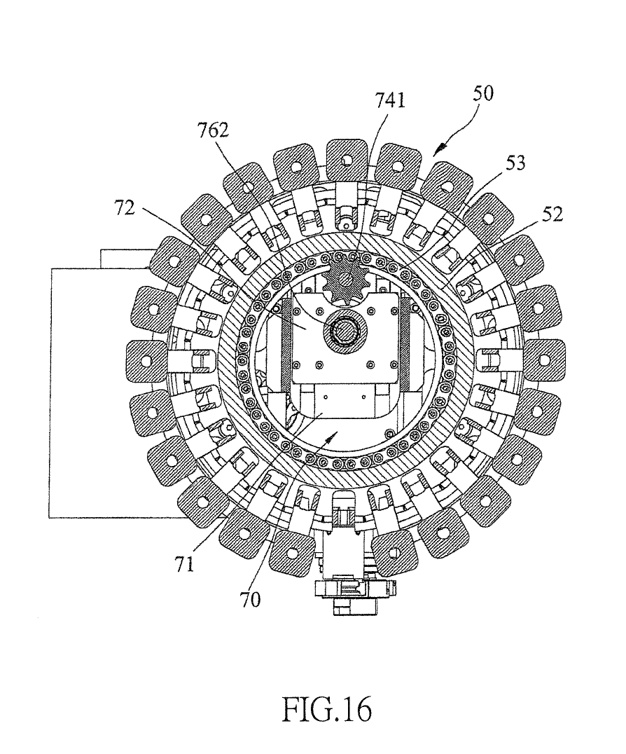

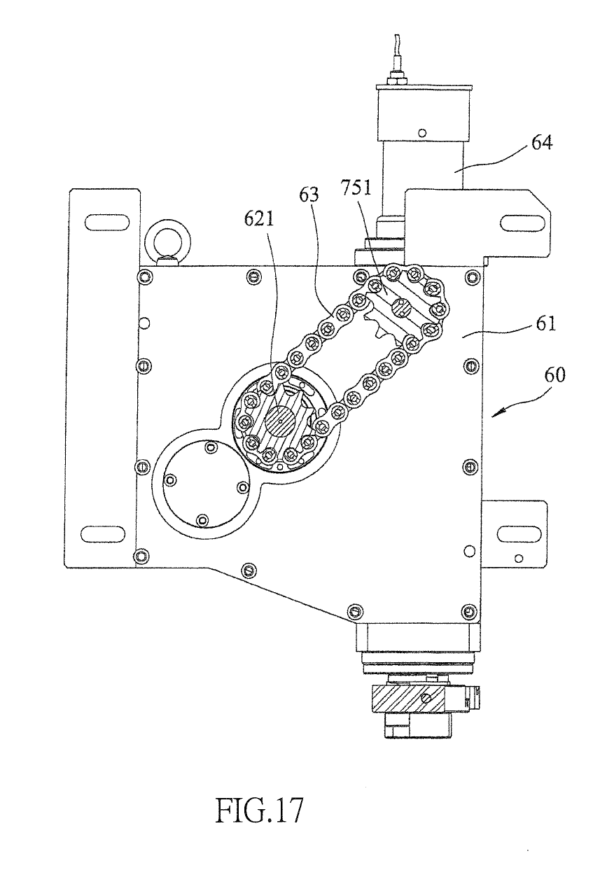

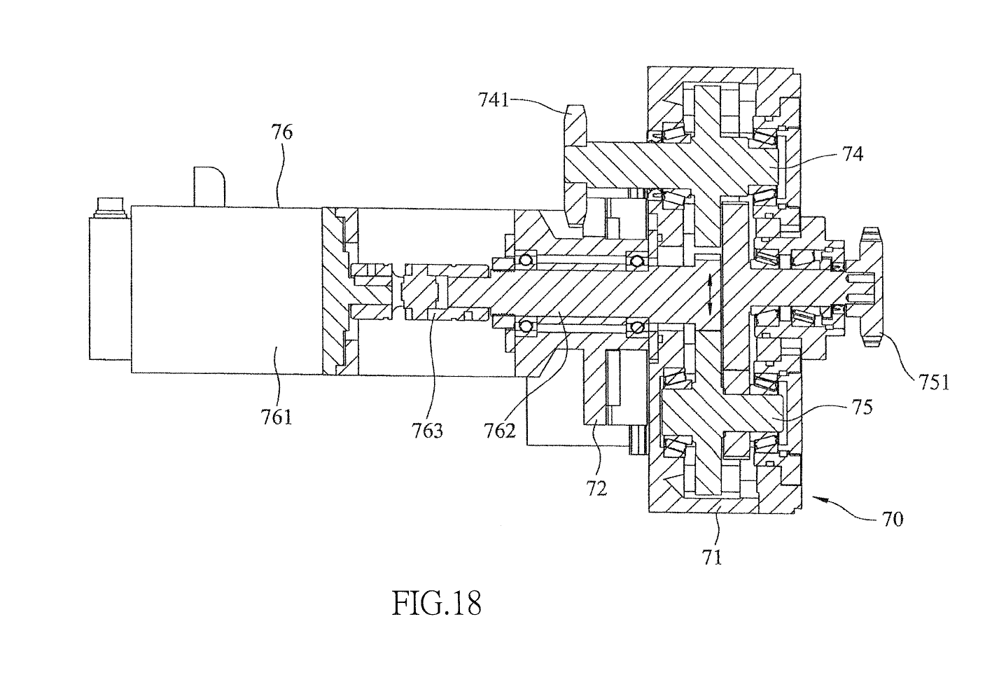

Besides the embodiment described above, the present invention provides additional modifications for various embodiments. Referring to FIGS. 14-18, the present invention provides a second preferred embodiment, which similarly comprises a tool magazine unit 50, a cam-based tool changing unit 60, and a power clutch unit 70. The tool magazine unit 50 comprises a tool magazine body 51, a rotatable disk 52, and a first rotation member 53. The cam-based tool changing unit 60 comprises a tool change base 61, a cam mechanism 62, a second rotation member 63, and a tool changing mechanism 64. A difference from the first embodiment is that the power clutch unit 70 is mounted at a central portion of the tool magazine unit 50 and comprises a fixed seat 71, a movable seat 72, a pusher assembly 73, a first force output axle 74, a second force output axle 75, and a power mechanism 76. The first force output axle 74 comprises a first chain wheel 741 mounted thereto, and the first chain wheel 741 is in engagement with an internal perimeter of the first rotation member 53 for driving the rotatable disk 52 to rotate to carry out the tool selection operation. The second force output axle 75 comprises a second chain wheel 751 mounted thereto and the second chain wheel 751 is engageable with the second rotation member 63 for transmission of power and drives the drive sprocket 621 of the cam mechanism 62 to rotate, so as to drive the tool changing mechanism 64 to carry out the tool change operation. This arrangement similarly achieves the effect of forwarding and changing tools with a single power source. Further, the power mechanism 76 comprises a motor 761, a power output spindle 762 rotatably mounted to the movable seat 72, and a universal joint 763 coupled between the motor 761 and the power output spindle 762. The motor 761 is fixedly mounted outside the fixed seat 71 and the universal joint 763 is movable with the movable seat 72 to allow for power transmission to the power output spindle 762 at any inclination angle. As such, the movable seat 72 does not carry the weight of the motor 761 and, even being set in a standstill position, the motor 761 is allowed to supply, in a normal way, power to the power output spindle 762 mounted on the movable seat 72.

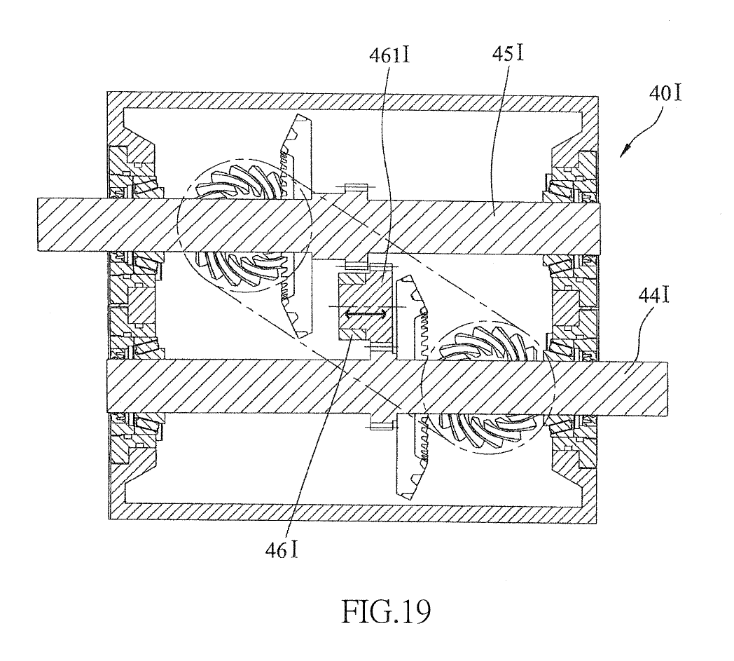

Further, the present invention provides a number of example embodiments of the brake member of the power clutch unit. Referring to FIG. 19, the present invention provides a third preferred embodiment, in which the power clutch unit 40I comprises a first force output axle 44I, a second force output axle 45I, and a linearly movable brake member 46I. The brake member 46I comprises a spur gear 461I mounted thereto. The spur gear 461I is selectively engageable with the first force output axle 44I or the second force output axle 45I to set up a locked condition therewith.

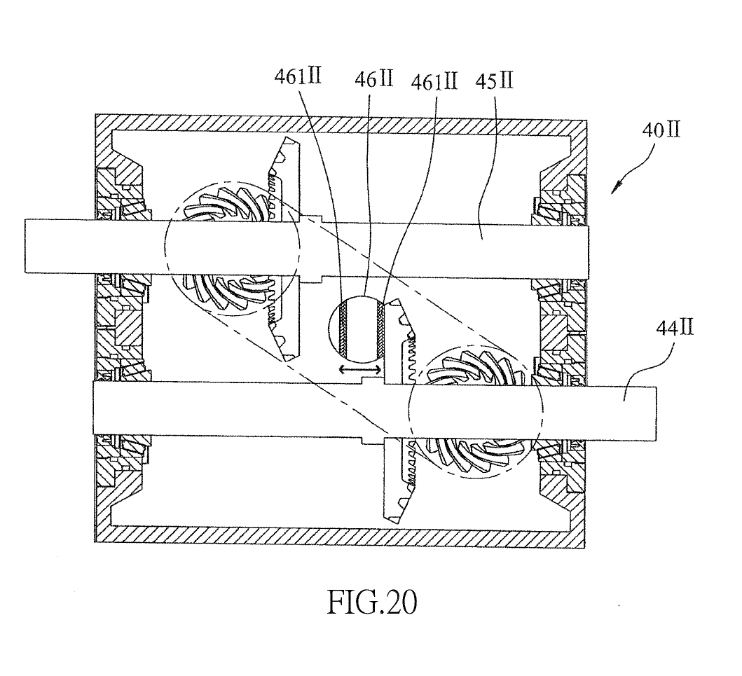

Referring to FIG. 20, the present invention provides a fourth preferred embodiment, in which the power clutch unit 40II comprises a first force output axle 44II, a second force output axle 45II, and a linearly movable brake member 46II. The brake member 46II comprises two friction surfaces 461II. The two friction surfaces 461II are respectively engageable with the first force output axle 44II and the second force output axle 45II to set up a locked condition therewith.

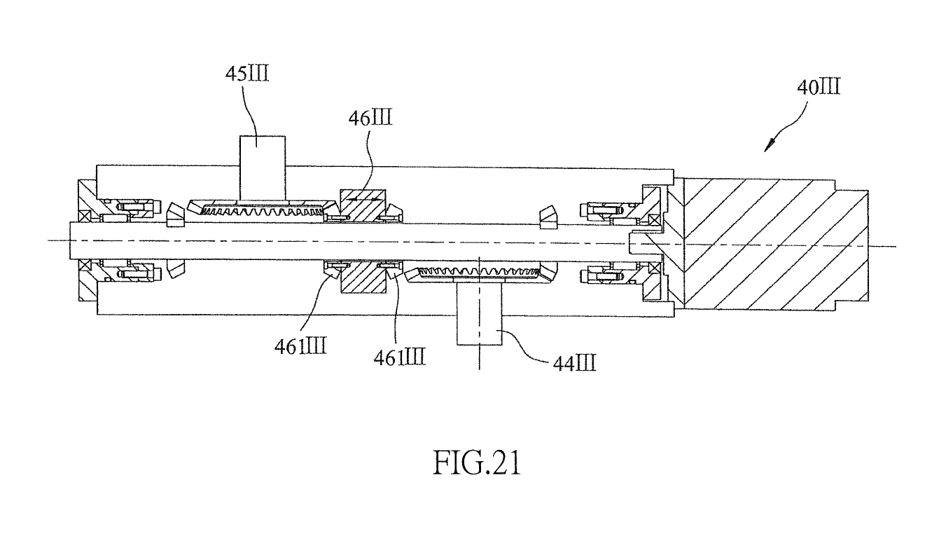

Referring to FIG. 21, the present invention provides a fifth preferred embodiment, in which the power clutch unit 40III comprises a first force output axle 44III, a second force output axle 45III, and a linearly movable brake member 46III. The brake member 46III has two ends to which two bevel gears 461III. The two bevel gears 461III are respectively engageable with the first force output axle 44III and the second force output axle 45III to set up a locked condition therewith.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A single power tool changing device of a CNC machining center, comprising:
a tool magazine unit, which comprises a tool magazine body, a rotatable disk that is rotatably mounted to the tool magazine body, a plurality of tool sets mounted on the rotatable disk, and a first rotation member operatively coupled to the rotatable disk, whereby rotation of the first rotation member causes the rotatable disk to rotate to carry out a tool section operation;
a cam-based tool changing unit, which comprises a tool change base disposed at one side of the tool magazine body, a cam mechanism arranged in the tool change base, a tool changing mechanism mounted on the tool change base and driven by the cam mechanism, and a second rotation member operatively coupled to the cam mechanism, the tool changing mechanism comprising a tool changing arm that is rotatably movable, whereby rotation of the second rotation member causes the cam mechanism to operate to have the tool changing arm carry out a tool change operation; and
a power clutch unit, which comprises a fixed seat, a movable seat slidably mounted on the fixed seat, a pusher assembly operable to selectively move the movable seat, a first force output axle mounted on the fixed seat to selectively drive the first rotation member to rotate, a second force output axle mounted on the fixed seat to selectively drive the second rotation member to rotate, and a power mechanism, the power mechanism comprising a motor and a power output spindle that is mounted on the movable seat and is operatively coupled to the motor, whereby the movement of the movable seat caused by the pusher assembly allows the power output spindle to selectively engage with the first or second force output axle for transmission of power.

2. The single power tool changing device of the CNC machining center according to claim 1, wherein the rotatable mounting of the rotatable disk to the tool magazine body comprises a circular mounting and a plurality of bearings that is arranged in a circumferential array in contacting engagement with the circular mounting.

3. The single power tool changing device of the CNC machining center according to claim 1, wherein the rotatable disk comprises a recessed portion forming an annual groove, the first rotation member comprising a first chain received and retained in the annual groove and a ring lid set on the annual groove to cover and constrain the first chain, the first force output axle comprising a first chain wheel engageable with the first chain for transmission of power.

4. The single power tool changing device of the CNC machining center according to claim 3, wherein the power clutch unit is mounted outside the tool magazine body and the first chain wheel engages an external perimeter of the first chain.

5. The single power tool changing device of the CNC machining center according to claim 3, wherein the power clutch unit is mounted at a central portion of the tool magazine body and the first chain wheel engages an internal perimeter of the first chain.

6. The single power tool changing device of the CNC machining center according to claim 1, wherein the cam mechanism comprises a drive sprocket and the second force output axle comprises a second chain wheel, the second rotation member comprising a second chain surrounding and coupled between the drive sprocket and the second chain wheel.

7. The single power tool changing device of the CNC machining center according to claim 1, wherein the first force output axle comprises a first transmission gear and the second force output axle comprises a second transmission gear, the power output spindle comprising a drive gear that is selectively engageable with the first or second transmission gear for transmission of power, the power clutch unit further comprising a first brake member that is movable with the movable seat to separably engage and thus lock the first transmission gear and a second brake member that is movable with the movable seat to separably engage and thus lock the second transmission gear.

8. The single power tool changing device of the CNC machining center according to claim 1, wherein the motor of the power mechanism is fixedly mounted to the fixed seat, the power output spindle being mounted to the movable seat and thus movable, a universal joint being coupled between the motor and the power output spindle to provide angle-variable inclination therebetween.
